(19) United States
(12) Patent Application Publication
(10) Pub. No.: US 2003/0010956 A1
(43) Pub. Date: Jan. 16, 2003

(54) Wood preservative composition

(76) Inventors: Allan Las, Bellevue, WA (US); Xianbin Liu, Basking Ridge, NJ (US); Ed Hoff, Valdosta, GA (US)

Correspondence Address: Kevin D. McCarthy, Esq., Hodgson Russ LLP, Suite 2000, One M&T Plaza, Buffalo, NY, 14203-2391, US

(21) Appl. No.: 09/880,597

(22) Filed: Jun. 13, 2001

(51) Int. Cl. C09K 3/00

(52) U.S. Cl. 252/380

(57) ABSTRACT

The present invention is directed to a wood preservative composition and a method of using the same. The wood preservative composition has an effective amount of a fungicidal and bactericidal metal compound, a triazole compound, and at least a first and/or a second quaternary ammonium compound. Alternatively, the wood preservative composition contains at least one additional agent, depending on the formulation. In one embodiment, the composition contains a mold inhibitor that is emulsified with the metal from the fungicidal and bactericidal metal compound in solution. In another embodiment, there is an effective amount of a boron compound. And in another embodiment, a combination of the boron compound and at least one amine compound.

### BACKGROUND OF THE INVENTION

1. Field of the Invention

The present invention relates to a wood preservative composition and method to use the same.

2. Description of Related Art

Wood preservative compositions have been used for numerous years. For example, Heuer et al., in U.S. Pat. No. 5,874,025, disclosed a wood preservative composition “comprising at least one copper compound and polyaspartic acid or derivative of the same, a triazole compound, and if appropriate at least one synergistically complementing other fungicide and/or insecticide[, and] if appropriate an emulsifier and/or a small amount of alkanolamine.” See abstract—bracketed material added for clarity.

Heuer et al. also disclosed that “wood preservatives based on inorganic copper compounds with alkanolamines as chelating agents” are known. Those preservatives, according to Heuer et al., have “high copper contents in comparison with known copper (and chromate) containing salts with a comparable copper content, and the efficacy of [those] compositions against wood-destroying Basidiomycetes is insufficient.” (Bracketed material added for clarity).

Heuer et al. also disclosed that “wood preservatives based on copper compounds and alkanolamines which comprise a triazole compound and an emulsifier or which comprise a phosphonium compound and which are effective against wood-destroying Basidiomycetes” are known.

Moreover, Heuer et al. disclosed that “synergistic mixtures for the protection of wood based on, for example, propiconazole and tebuconazole . . . , if appropriate with the use of an insecticide as a component in the mixture, have also been disclosed.”

These compositions, however, do not provide, in the Applicant's opinion, sufficient protection to the wood or wood-containing product.

### SUMMARY OF THE INVENTION

The present invention is directed to a wood preservative composition and a method of using the same. The wood preservative composition has an effective amount of a fungicidal and bactericidal metal compound, a triazole compound, and at least a first and/or a second quaternary ammonium compound. The first quaternary ammonium compound has the structure:

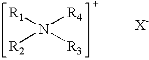

and the second quaternary ammonium compound has the structure:

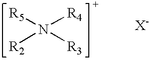

wherein

R₁ is selected from the from the group consisting of a C₂₋₃₀ alkyl group, a C₂₋₃₀ alkenyl group, a C₂₋₃₀ alkynyl group, a C₂₋₃₀ aryl group, a C₂₋₃₀ aralkyl group, a C₂₋₃₀ aroyl group, a C₂₋₃₀ acyl group, a C₂₋₃₀ cycloalkyl group, C₂₋₃₀ cycloalkenyl group, or a C₂₋₃₀ cycloalkynyl group; preferably, the C₂₋₃₀ groups cited immediately above are C₁₂₋₁₅ groups;

R₂ and R₃ can be the same or different and are independently selected from the group consisting of a C₁₋₄ hydroxyalkyl group, a C₁₋₄ alkyl group, a C₂₋₅ hydroxyalkenyl group, a C₂₋₅ hydroxyalkynyl group, a C₃₋₅ hydroxyaryl group;

R₄ is a C₁₋₄ alkyl group, a C₂₋₅ alkenyl group, a C₂₋₅ alkynyl group, a C₃₋₅ aryl group;

R₅ is a C₁₂₋₂₀ alkyl group, a C₁₂₋₂₀ alkenyl group, a C₁₂₋₂₀ alkynyl group, a C₁₂₋₂₀ aryl group, a C₁₂₋₂₀ aralkyl group, a C₁₂₋₂₀ aroyl group, a C₁₂₋₂₀ acyl group, a C₁₂₋₂₀ cycloalkyl group, C₁₂₋₂₀ cycloalkenyl group, or a C₁₂₋₂₀ cycloalkynyl group, preferably, the C₁₂₋₂₀ groups cited above are C₁₆₋₂₀ groups; and

X is selected from the group consisting of a chloride, bromide, carbonate, sulfate, acetate or phosphate ion.

The wood preservative composition may also contain at least one additional ingredient, depending on the formulation. In one embodiment, the composition may contain a mold inhibitor that is emulsified with the metal from the fungicidal and bactericidal metal compound in solution. In another embodiment, there could be an effective amount of a boron compound. And in yet another embodiment, the composition could have a combination of the boron compound and at least one amine compound.

### DETAILED DESCRIPTION OF THE PREFERRED EMBODIMENTS

The present wood preservative composition is a water-dilutable preservative concentrate used to protect wood against decay (soft rot, brown rot and white rot), termite attack, other wood ingesting insects, and staining fungi (blue stain). It is to designed to be used for application by pressure, vacuum, and/or vacuum-pressure treatment to lumber, timbers, shingles and shakes, siding, plywood, and engineered wood composites used in above ground and below ground applications. It is recommended that this product not be used on wood that will come in direct contact with food.

The wood that the wood preservative will be applied to can be machined, cut, glued, and/or sand wood as desired before treating. The wood must be clean and dry before treatment. Preferably, the wood should be kiln dried or air seasoned to a moisture content of about 25% or less which will permit adequate penetration of preservative during treatment.

The present invention has at least two active ingredients that must be in the composition. The first active ingredient is a triazole compound, for example, a cyproconazole like α-(4-chlorophenyl)-α-(1-cyclopropylethyl)-1H-1,2,4-triazole-1-ethanol, and, preferably, in its racemic form. The second active ingredient is a fungicidal and bactericidal metal compound, like basic copper carbonate. The other ingredients are active in one way or another.

A general ratio of these active ingredients in the concentrate form is set forth in Table 1.

TABLE 1

| | |
|---|---|
| α-(4-chlorophenyl)-α-(1-cyclopropylethyl)-1H- | 1.5% |
| 1,2,4-triazole-1-ethanol | |
| Basic Copper Carbonate | 17.5% |
| Other Ingredients: | 81.0% |
| Total: | 100.0% |

As shown in Table 1, the wood preservative composition has an effective amount, but not limited to the amounts disclosed in Table 1, of (1) the fungicidal and bactericidal metal compound, (2) the triazole compound, and (3) one of the other ingredients is at least a first quaternary ammonium compound. Preferably, the first quaternary ammonium compound is combined with a distinct second quaternary ammonium compound. The combination of the two distinct quaternary ammonium compounds increases the stability and corrosion resistance of the wood preservative compound.

The first quaternary ammonium compound has the structure:

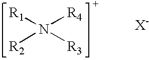

and the second quaternary ammonium compound has the structure:

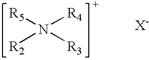

wherein

R₁ is selected from the from the group consisting of a C₂₋₃₀ alkyl group, a C₂₋₃₀ alkenyl group, a C₂₋₃₀ alkynyl group, a C₂₋₃₀ aryl group, a C₂₋₃₀ aralkyl group, a C₂₋₃₀ aroyl group, a C₂₋₃₀ acyl group, a C₂₋₃₀ cycloalkyl group, C₂₋₃₀ cycloalkenyl group, or a C₂₋₃₀ cycloalkynyl group; and preferably, the C₂₋₃₀ groups cited immediately above are C₁₂₋₁₅ groups to obtain a distinctiveness from the first and second quaternary ammonium compounds;

R₂ and R₃ can be the same or different and are independently selected from the group consisting of a C₁₋₄ hydroxyalkyl group, a C₁₋₄ alkyl group, a C₂₋₅ hydroxyalkenyl group, a C₂₋₅ hydroxyalkynyl group, a C₃, hydroxyaryl group;

R₄ is selected from the group consisting of a C₁₋₄ alkyl group, a C₂, alkenyl group, a C₂₋₅ alkynyl group, a C₃₋₅ aryl group;

R₅ is selected from the group consisting of a C₁₂₋₂₀ alkyl group, a C₁₂₋₂₀ alkenyl group, a C₁₂₋₂₀ alkynyl group, a C₁₂₋₂₀ aryl group, a C₁₂₋₂₀ aralkyl group, a C₁₂₋₂₀ aroyl group, a C₁₂₋₂₀ acyl group, a C₁₂₋₂₀ cycloalkyl group, C₁₂₋₂₀ cycloalkenyl group, or a C₁₂₋₂₀ cycloalkynyl group, preferably, the C₁₂₋₂₀ groups cited above are C₁₆₋₂₀ groups; and

X is selected from the group consisting of a chloride, bromide, carbonate, sulfate, acetate or phosphate ion.

The preferred first quaternary ammonium compound is obtained from Goldschmidt and is designated Variquat 638. The Variquat 638 formulation has R₁ as C₁₂₋₁₅, R₂ and R₃ as hydroxyethyl, R₄ as methyl, and X as a chloride ion. The second quaternary ammonium compound is also obtained from Goldschmidt, and its common name is S-1202U. This compound has a formulation wherein R₅ is C₁₈, R₂ and R₃ are hydroxyethyl, R₄ is methyl, and X is a chloride ion.

The fungicidal, insecticidal, and bactericidal metal compound will generate a metal cation within a solution. An effective cation is copper or zinc. The desired cation can be obtained from Cu(OH)₂, CuSO₄, Cu(ClO₄)₂, Cu₂O, Cu(NO₃)₂, CuCl₂, 3Cu(OH)₂.CuCl₂, Cu(OH)₂.CuCO₃, 3Cu(OH)₂.CuSO₄, Zn(OH)₂, ZnSO₄, Zn(ClO₄)₂, Zn₂O, Zn(NO₃)₂, ZnCl₂, 3Zn(OH)₂.ZnCl₂, Zn(OH)₂.ZnCO₃, and 3Zn(OH)₂.ZnSO₄. Preferably, the cation is copper and comes from copper carbonate, Cu(OH)₂.CuCO₃.

The triazole is selected from the group consisting of hexaconazole, difenoconazole, tebuconazole, propiconazole, azaconazole, and cyproconazole. And when the triazole is a cyproconazole then it can be α-(4-chlorophenyl)-α-(1-cyclopropylethyl)-1H-1,2,4-triazole-1-ethanol. Preferably, the α-(4-chlorophenyl)-α-(1-cyclopropylethyl)-1H-1,2,4-triazole-1-ethanol compound is used in its racemic form.

Synergistic mixtures of triazole compounds, for example, tebuconazole, are preferably combined with one or more fungicides from the series consisting of: azaconazole, bromuconazole, cyproconazole, dichlobutrazol, diniconazole, hexaconazole, metconazole, penconazole, epoxyconazole, methyl (E)-methoximino .alpha.-(o-tolyloxy)-o-tolyl)acetate, methyl (E)-2-{2-6-(2-cyanophenoxy)-pyrimidin-4-yl-oxyphenyl}-3-methoxyacrylate, methfuroxam, carboxin, fenpiclonil, 4(2,2-difluoro-1,3-benzodioxol-4-yl)-1H-pyrrole-3-carbonitrile, butenafine, 3-iodo-2-propyl -butylcarbamate (IPBC), polymeric quaternary ammonium borates and/or quaternary ammonium compounds, such as benzyldimethyltetradecylammonium chloride, benzyldimethyldodecylammonium chloride, and didecyldimethaylammonium chloride.

As stated above, triazoles are known insecticides and/or fungicides for the wood preserving compositions. The present invention has found that if the wood preserving compositions contain tebuconazole as the sole fungicide, or synergistic mixtures thereof, then the results are superior to other wood preserving insecticides and/or fungicides. The synergistic mixtures include and are not limited to (A) tebuconazole and cyproconazole and, optionally, bromoconazole and/or hexaconazole and/or propiconazole and/or tridemorph; (B) tebuconazole and metconazole and, optionally, cyproconazole and/or hexaconazole and/or tridemorph; (C) tebuconazole and hexaconazole and, optionally, cyproconazole and/or metconazole and/or bromoconazole and/or tridemorph; (C) tebuconazole and 1-(2-chlorophenyl)-2-(1-chloro-cycloprop-1-yl)-3-(1,2,4-triazol-1-yl)-prop an-2-ol and, optionally cyproconazole and/or metconazole and/or bromoconazole and/or hexaconazole and/or tridemorph; (D) tebuconazole and tridemorph and, optionally, cyproconazole and/or propiconazole and/or bromoconazole and/or hexaconazole and/or penconazole; (E) tebuconazole and propiconazole and, optionally, cyproconazole and/or bromoconazole and/or hexaconazole and/or metconazole and/or tridemorph and/or penconazole and/or 1-(2-chlorophenyl)-2-(1-chlorocycloprop-1-yl)-3-(1,2,4-triazol-1-yl)-propa-2-ol; (F) cyproconazole and bromoconazole and/or metconazole and/or hexaconazole and/or tridemorph; (G) hexaconazole and bromoconazole and/or metconazole and/or penconazole and/or tridemorph; (H) penconazole and cyproconazole and/or metconazole and/or bromoconazole and/or tridemorph.

One advantage of these triazole compounds in each embodiment of the present wood preservative composition is that each triazole compound, which is not soluble in water, exists in the novel wood preservative composition in the form of an aqueous emulsion or a clear aqueous concentrate. Clear aqueous fluids are formed upon dilution with water. Obtaining a clear wood preservative composition is desirable for not altering the color of the wood.

Even though the wood preservative comprises copper HIS compounds, the additional ingredients are distributed, emulsified or dissolved to generate a clear wood preserving fluid upon dilution with water. The additional other ingredients include and, are not limited to, a mold inhibitor that is emulsified with the metal from the fungicidal and bactericidal metal compound in solution, an effective amount of a boron compound, and a combination of the boron compound and at least one amine compound.

The mold inhibitor can be any conventional mold inhibitor like tribromophenol.

The boron compound can be a synergistic fungicidal or insecticidal component in the composition. The preferred boron compound is selected from the group consisting of alkali metal borate, amine borate, boric acid, salts of boric acid, boric ester, fluoroboric acid, and salts of fluoroboric acid.

The other additional ingredients can control the pH of the wood preservative composition to range between 5 and 14. In a particularly preferred form, the pH for the wood preservative composition ranges from 7 to 12, by adding a basic ingredient. Suitable basic ingredients are amines such as triethylamine, triethanolamine, diethylamine, alkanolamine, alkylamines and the like. In particular, the alkanolamine can be monoethanolamine or diethanolamine. The use of other alkanolamines can include, for example, isopropanolamine 1,1-, 1,2-diaminoethanol, aminoethylethanolamine, diethanolamine, triethanolamine, methylethanolamine, N-methylaminoethanol, ethylaminoethanol, ethanolhydrazine, butylaminoethanol, N-phenylaminoethanol and (2-aminoethoxy)ethanol are acceptable as well.

An emulsifier is another additional ingredient that can be incorporated into the wood preserving composition. The emulsifier can be an anionic, cationic or non-ionic component or a mixture thereof. Non-ionic emulsifiers are, for example, adducts of ethylene oxide or propylene oxide or mixtures thereof to organic hydroxy compounds, for example alkylphenols, fatty acid, fatty alcohols and mixtures of these. Cationic emulsifiers which may be used are, for example, quaternary ammonium compounds which are disclosed above.

As stated above, water is used as a solvent in the wood preservative composition. Other solvents and/or diluents for the wood preservative composition can also be used. Such solvents include an organochemical solvent, an oily or an oil-type organochemical solvent, a solvent of low volatility, and/or a polar organochemical solvent.

Organochemical solvents which are preferably employed are oily or oil-type solvents with an evaporation number of above 35 and a flash point of above 30° C., preferably above 45° C. Such water-insoluble, oily and oil-type solvents of low volatility are conventional mineral oils, their aromatic fractions or mineral-oil-containing solvent mixtures, preferably white spirit, petroleum and/or alkyl benzene.

Mineral oils which are preferably used are those with a boiling range of from 170° to 220° C., white spirit with a boiling range of 170° to 220° C., spindle oil with a boiling range of from 250° to 350° C., and petroleum and aromatic compounds with a boiling range of from 160° to 280° C.

In a preferred embodiment, the solvent can be liquid aliphatic hydrocarbons with a boiling range of from 180° to 210° C. or high-boiling mixtures of aromatic and aliphatic hydrocarbons with a boiling range of 180° to 220° C. and/or monochloronaphthalene. When monochloroapthalene is used, the solvent is α-monochloronaphthalene.

When the organic oily or oil-type solvents are used, the solvents have a low volatility, an evaporation number of above 35, a flash point of above 30° C. preferably above 45° C. Such solvents can be replaced in part by organochemical solvents of high or medium volatility. Such substitution is permissible under the proviso that the solvent mixture also has an evaporation number of above 35 and a flashpoint of above 30° C., preferably 45° C., and that the insecticide/fungicide mixture is soluble or emulsifiable in this solvent mixture.

The active compound combinations of the wood preserving composition display a particularly high microbicidal, in particular fungicidal, activity with a broad spectrum of action against microorganisms and insects which are relevant in the protection of wood. The active compounds act mainly against molds, wood-discoloring and wood-destroying fungi and insects.

The concentration of the wood preservative compound employed depends on the species and on the incidence of the insects, the microorganisms, the microbiological count and the medium. The optimum amount used can be determined for each use by a test series. In most instances, the wood preservative compound has a formula wherein the fungicidal and bactericidal metal compound is at least 8 percent by weight of the composition, the triazole compound is at least 0.10 percent by weight of the composition, and the combination of the first and second quaternary ammonium compounds is at least 2 percent by weight of the composition.

In another embodiment, the metal content of the fungicidal, insecticide, and/or bactericidal ingredient is at least 8 percent by weight of the wood preservative composition, the triazole compound is at least 0.10 percent by weight of the composition, the combination of the first and second quaternary ammonium compounds is at least 2 percent by weight of the composition, and the boron compound is at least 5 percent by weight of the composition.

In particular, the composition can have the metal content of the fungicidal, insecticide, and/or bactericidal ingredient ranging from 8 to 22 percent by weight of the composition, the triazole compound ranging from 0.10 to 3 percent by weight of the composition, the combination of the first and second quaternary ammonium compounds ranging from 2 to 15 percent by weight of the composition, and the boron compound ranging from 5 to 15 percent by weight of the composition.

The invention not only extends to the wood preservatives (concentrates), but, equally, also to the impregnating solutions of correspondingly lower individual concentrations. The individual concentrations can be prepared by diluting the concentrates with water. For example, the individual use concentration of the wood preservative composition is 0.01 to 1.50% by weight of metal, for example copper, in the aqueous impregnating solution, depending on the type of impregnation and the degree of destruction risk (like wood rot) of the wood to be impregnated.

The impregnating solution for the protection of wood can be applied by manual processes, such as spraying, brushing on, immersion or vat soaking, or by industrial-scale processes, such as boiler pressure, alternating-pressure and double-vacuum processes. =“Wood” is to be understood as meaning both solid wood and wood-based materials such as chipboard, plywood. Moreover, wood which can be protected by the composition includes, and is not limited to, construction timber, wooden beams, railway sleepers, bridge components, jetties, wooden vehicles, boxes, pallets, containers, telephone poles, wooden claddings, windows and doors made from wood, plywood, chipboard, joiners' work or wood-based materials which quite generally are used in domestic construction or in joinery. Particularly effective protection of wood is achieved by industrial-scale impregnating processes, for example vacuum, double-vacuum or pressure processes.

1. First embodiment: Applicant has proposed three different formulations for the first embodiment. Those formulations are as follows:

Noah Gold

| Ingredient | Percent by Weight |
|---|---|
| Cu as metal | 10% |
| 2-Quats | 8.25% |
| Azole Fungicide (s) | 1-1.5% |
| Copper metal retention, | collectively the metal |
| pcf | in the entire |
| | composition totals |
| | about 10% |
| Cyproconazole | collectively the azole |
| retention, pcf | composition in the |
| | entire composition |
| | totals 1-1.5% |
| Assumed solution | |
| absorption, pcf | |
| CuCO₃.Cu(OH)₂ | see above |
| Monoethanolamine (MEA) | |
| Triethanolamine (TEA) | |
| Boric Acid (H3BO₃) | |
| Cyproconazole | see above |
| 1-methyl-2- | |
| pyrrolidinone (NMP) | |
| Variquat 638 and | 8.25 |
| Variquat S1202U | |
| Total | 100.0% |

GX-568 Brightener

| Ingredient | Percent by Weight |
|---|---|
| Tribromo phenol (“TBP”) | 25% |
| Quat | 50% |

DSA Water Repellent

| Ingredient | Percent by Weight |
|---|---|
| TBP | 5% |

GX-568 Brightener or DSA Water Repellent are added to the present composition only after substantial dilution of the present composition into a working strength used to pressure treat wood. Minimal levels found in southern pine when the Noah Gold is applied in either case are:

| Ingredient | Percent by Weight | |
|---|---|---|
| Cu as metal | 1000 | ppm |
| Quats | 2025 | ppm |
| Azole fungicide | 100-150 | ppm |
| TBP | 800 | ppm |

The two quat blend used in present composition comprises a Goldschmidt product designated Variquat 638 present at 7.5% of formulated product and S-1202U present at 0.75% of formulated product. The chemical structure of the first quat is shown below:

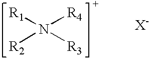

and the second quaternary ammonium compound has the structure:

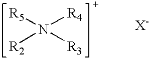

and

R₁ is selected from the from the group consisting of a C₂₋₃₀ alkyl group, a C₂₋₃₀ alkenyl group, a C₂₋₃₀ alkynyl group, a C₂₋₃₀ aryl group, a C₂₋₃₀ aralkyl group, a C₂₋₃₀ aroyl group, a C₂₋₃₀ acyl group, a C₂₋₃₀ cycloalkyl group, C₂₋₃₀ cycloalkenyl group, or a C₂₋₃₀ cycloalkynyl group; preferably, a C₁₂₋₁₅ alkyl group, a C₁₂₋₁₅ alkenyl group, a C₁₂₋₁₅ alkynyl group, a C₁₂₋₁₅ aryl group, a C₁₂₋₁₅ aralkyl group, a C₁₂₋₁₅ aroyl group, a C₁₂₋₁₅ acyl group, a C₁₂₋₁₅ cycloalkyl group, C₁₂₋₁₅ cycloalkenyl group, or a C₁₂₋₁₅ cycloalkynyl group;

R₂ and R₃ can be the same or different and are independently selected from the group consisting of a C₁₋₄ hydroxyalkyl group, a C₁₋₄ alkyl group, a C₂₋₅ hydroxyalkenyl group, a C₂₋₅ hydroxyalkynyl group, a C₃₋₅ hydroxyaryl group;

R₄ is selected from the group consisting of a C₁₋₄ alkyl group, a C₂₋₅ alkenyl group, a C₂₋₅ alkynyl group, a C₃₋₅ aryl group;

R₅ is selected from the group consisting of a C₁₂₋₂₀ alkyl group, a C₁₂₋₂₀ alkenyl group, a C₁₂₋₂₀ alkynyl group, a C₁₂₋₂₀ aryl group, a C₁₂₋₂₀ aralkyl group, a C₁₂₋₂₀ aroyl group, a C₁₂₋₂₀ acyl group, a C₁₂₋₂₀ cycloalkyl group, C₁₂₋₂₀ cycloalkenyl group, or a C₁₂₋₂₀ cycloalkynyl group, preferably, the C₁₂₋₂₀ groups cited above are C₁₆₋₂₀ groups; and

X is selected from the group consisting of a chloride, bromide, carbonate, sulfate, acetate or phosphate ion.

| | Percent by |
|---|---|
| 2. Second embodiment | Weight |
| Copper metal retention, pcf | 0.040 |
| Cyproconazole retention, pcf | 0.0060 |
| Assumed solution absorption, pcf | 35.0 |
| CuCO₃.Cu(OH)₂ | 18.20 |
| Monoethanolamine (MEA) | 37.00 |
| Triethanolamine (TEA) | 5.00 |
| Boric Acid (H₃BO₃) | 8.00 |
| H₂O | 17.24 |
| Cyproconazole | 1.56 |
| 1-methyl-2-pyrrolidinone (NMP) | 2.00 |
| Variquat 638 | 10.00 |
| Variquat S1202U | 1.00 |
| Total | 100.0% |

% In Product for the Second Embodiment

| Cu | Amines | H₃BO₃ | Cypo | NMP | Quats |
|---|---|---|---|---|---|
| 10.01 | 42.00 | 8.00 | 1.50 | 2.00 | 11.00 |

| | |
|---|---|
| Required solution strength % for S. | 1.14 |

Pine =

Retention in Wood, pcf for the Second Embodiment

| Cu | Amines | H₃BO₃ | Cypro | NMP | Quats |
|---|---|---|---|---|---|
| 0.040 | 0.168 | 0.032 | 0.0060 | 0.0080 | 0.0440 |

| | |
|---|---|
| Ratio of amine to copper = | 4.2 |
| Ratio of copper to cypro = | 6.7 |

| 3. Third Embodiment | Percent by Weight |
|---|---|
| Copper metal retention, | 0.20 |
| pcf | |
| Cyproconazole retention, | 0.0030 |
| pcf | |
| Assumed solution | 35.0 |
| absorption, pcf | |
| Copper Solution | |
| CuCO₃.Cu(OH)₂ | 18.20 |
| Monoethanolamine (MEA) | 41.00 |
| Triethanolamine (TEA) | 5.00 |
| Boric Acid | 8.00 |
| Water | 25.39 |
| Cyproconazole Solution | |
| Cyproconazole | 0.16 |
| 2-Quats total | 2.5 |

% In Product for the Third Embodiment

| Cu | Amines | H₃BO₃ | Cypo | NMP | Quats |
|---|---|---|---|---|---|
| 10.01 | 46.00 | 8.00 | 0.15 | 0.00 | 2.25 |

| | |
|---|---|
| Required solution strength % for S. | 5.71 |
| Pine = | |

Retention in Wood, pcf for the Third Embodiment

| Cu | Amines | H₃BO₃ | Cypro | NMP | Quats |
|---|---|---|---|---|---|
| 0.200 | 0.919 | 0.160 | 0.0030 | 0.0000 | 0.0450 |

| | |
|---|---|
| Ratio of amine to copper = | 4.6 |
| Ratio of copper to cypro = | 66.7 |

When using the wood preservative product, the concentrated composition is diluted with water (or other acceptable solvent) to provide a working Ready-To-Use (RTU) solution (4 to 100 gallons of present invention per 1,000 gallons of RTU solution). The dilution rate is dependent upon wood species, method of application and the intended use of the treated wood product.

Apply RTU dilution by pressure treatment processes (double vacuum, full-cell or modified full-cell). All treated wood must be held on the drip pad until drippage has stopped. Surfaces cut after first treatment may be retreated using brush-applied Noah Gold CS concentrate full strength.

To clean up the present composition, the user can apply soap and water to remove wet wood preservative from all surfaces. The application can be applied by brushes and rollers.

The compositions according to the invention allow in an advantageous manner the compositions available to date to be replaced by more efficient ones. They have good stability and, in an advantageous manner, display a broad spectrum of action.

Although variations in the embodiment of the present invention may not each realize all the advantages of the invention, certain features may become more important than others in various applications of the device. The invention, accordingly, should be understood to be limited only by the scope of the appended claims.

We claim:

1. A wood preservative composition comprising
an effective amount of a combination of at least a first and a second quaternary ammonium compound, wherein the first quaternary ammonium compound has the structure: 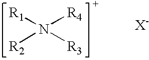
and the second quaternary ammonium compound has the structure: 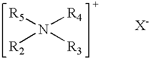
and
R₁ is selected from the from the group consisting of a C₂₋₃₀ alkyl group, a C₂₋₃₀ alkenyl group, a C₂₋₃₀ alkynyl group, a C₂₋₃₀ aryl group, a C₂₋₃₀ aralkyl group, a C₂₋₃₀ aroyl group, a C₂₋₃₀ acyl group, a C₂₋₃₀ cycloalkyl group, C₂₋₃₀ cycloalkenyl group, or a C₂₋₃₀ cycloalkynyl group;
R₂ and R₃ can be the same or different and are independently selected from the group consisting of a C₁₋₄ hydroxyalkyl group, a C₁₋₄ alkyl group, a C₂₋₅ hydroxyalkenyl group, a C₂₋₅ hydroxyalkynyl group, a C₃, hydroxyaryl group;
R₄ is selected from the group consisting of a C₁₋₄ alkyl group, a C₂₋₅ alkenyl group, a C₂₋₅ alkynyl group, a C₃₋₅ aryl group;
R₅ is selected from the group consisting of a C₁₂₋₂₀ alkyl group, a C₁₂₋₂₀ alkenyl group, a C₁₂₋₂₀ alkynyl group, a C₁₂₋₂₀ aryl group, a C₁₂₋₂₀ aralkyl group, a C₁₂₋₂₀ aroyl group, a C₁₂₋₂₀ acyl group, a C₁₂₋₂₀ cycloalkyl group, C₁₂₋₂₀ cycloalkenyl group, or a C₁₂₋₂₀ cycloalkynyl group; and
X is selected from the group consisting of a chloride, bromide, carbonate, sulfate, acetate or phosphate ion;
an effective amount of a fungicidal and bactericidal metal compound;
an effective amount of a triazole compound; and
a mold inhibitor that is emulsified with the metal from the fungicidal and bactericidal metal compound in solution.

2. The composition of claim 1 wherein the triazole compound is a cyproconazole.

3. The composition of claim 2 wherein the cyproconazole is α-(4-chlorophenyl)-α-(1-cyclopropylethyl)-1H-1,2,4-triazole-1-ethanol.

4. The composition of claim 1 wherein the triazole compound is selected from the group consisting of hexaconazole, difenoconazole, tebuconazole, propiconazole, azaconazole, and cyproconazole.

5. The composition of claim 1 wherein the mold inhibitor is a tribromophenyl.

6. The composition of claim 1 wherein the fungicidal and bactericidal metal compound is a copper compound.

7. The composition of claim 6 wherein copper compound is selected from the group consisting of Cu(OH)₂1 CuSO₄, Cu(ClO₄)₂, Cu₂O, Cu(NO₃)₂, CuCl₂, 3Cu(OH)₂.CuCl₂, Cu(OH)₂.CuCO₃, and 3Cu(OH)₂.CuSO₄.

8. The composition of claim 6 wherein the copper compound is copper carbonate.

9. The composition of claim 1 wherein the fungicidal and bactericidal metal compound is a zinc compound.

10. The composition of claim 9 wherein the zinc compound is selected from the group consisting of Zn(OH)₂, ZnSO₄, Zn(ClO₄)₂, Zn₂O, Zn(NO₃)₂, ZnCl₂, 3Zn(OH)₂.ZnCl₂, Zn(OH)₂.ZnCO₃, and 3Zn(OH)₂ZnSO₄.

11. The composition of claim 1 wherein the fungicidal and bactericidal metal compound is at least 8 percent by weight of the composition, the triazole compound is at least 0.10 percent by weight of the composition, and the combination of the first and second quaternary ammonium compounds is at least 2 percent by weight of the composition.

12. The composition of claim 1 further comprising a boron compound and wherein R₁ is selected from the group consisting of a C₁₂₋₁₅alkyl group, a C₁₂₋₁₅ alkenyl group, a C₁₂₋₁₅ alkynyl group, a C₁₂₋₁₅ aryl group, a C₁₂₋₁₅ aralkyl group, a C₁₂₋₁₅ aroyl group, a C₁₂₋₁₅ acyl group, a C₁₂₋₁₅ cycloalkyl group, C₁₂₋₁₅ cycloalkenyl group, or a C₁₂₋₁₅ cycloalkynyl group; and R₅ has the C₁₂₋₂₀ groups are C₁₆₋₂₀ groups.

13. The composition of claim 12 wherein the boron compound is selected from the group consisting of alkali metal borate, amine borate, boric acid, salts of boric acid, boric ester, fluoroboric acid, and salts of fluoroboric acid.

14. A wood preservative composition comprising an effective amount of a combination of at least a first and a second quaternary ammonium compound, wherein the first quaternary ammonium compound has the structure: 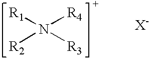
and the second quaternary ammonium compound has the structure: 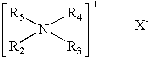
and
R₁ is selected from the from the group consisting of a C₂₋₃₀ alkyl group, a C₂₋₃₀ alkenyl group, a C₂₋₃₀ alkynyl group, a C₂₋₃₀ aryl group, a C₂₋₃₀ aralkyl group, a C₂₋₃₀ aroyl group, a C₂₋₃₀ acyl group, a C₂₋₃₀ cycloalkyl group, C₂₋₃₀ cycloalkenyl group, or a C₂₋₃₀ cycloalkynyl group;
R₂ and R₃ can be the same or different and are independently selected from the group consisting of a C₁₋₄ hydroxyalkyl group, a C₁₋₄ alkyl group, a C₂₋₅ hydroxyalkenyl group, a C₂₋₅ hydroxyalkynyl group, a C₃₋₅ hydroxyaryl group;
R₄ is selected from the group consisting of a C₁₋₄ alkyl group, a C₂₋₅ alkenyl group, a C₂₋₅ alkynyl group, a C₃₋₅ aryl group;
R₅ is selected from the group consisting of a C₁₂₋₂₀ alkyl group, a C₁₂₋₂₀ alkenyl group, a C₁₂₋₂₀ alkynyl group, a C₁₂₋₂₀ aryl group, a C₁₂₋₂₀ aralkyl group, a C₁₂₋₂₀ aroyl group, a C₁₂₋₂₀ acyl group, a C₁₂₋₂₀ cycloalkyl group, C₁₂₋₂₀ cycloalkenyl group, or a C₁₂₋₂₀ cycloalkynyl group; and
X is selected from the group consisting of a chloride, bromide, carbonate, sulfate, acetate or phosphate ion;
a fungicidal and bactericidal metal compound;
an effective amount of a triazole compound; and
an effective amount of a boron compound.

15. The composition of claim 14 wherein the triazole compound is a cyproconazole.

16. The composition of claim 15 wherein the cyproconazole is α-(4-chlorophenyl)-α-(1-cyclopropylethyl)-1H-1,2,4-triazole-1-ethanol.

17. The composition of claim 14 wherein the triazole compound is selected from the group consisting of hexaconazole, difenoconazole, tebuconazole, propiconazole, azaconazole, and cyproconazole.

18. The composition of claim 14 wherein the mold inhibitor is a tribromophenyl.

19. The composition of claim 14 wherein the fungicidal and bactericidal metal compound is a copper compound.

20. The composition of claim 19 wherein copper compound is selected from the group consisting of Cu(OH)₂, CuSO₄, Cu(ClO₄)₂, Cu₂O, Cu(NO₃)₂, CuCl₂, 3Cu(OH)₂.CuCl₂, Cu(OH)₂.CuCO₃, and 3Cu(OH)₂.CuSO₄.

21. The composition of claim 19 wherein the copper compound is copper carbonate.

22. The composition of claim 14 wherein the fungicidal and bactericidal metal compound is a zinc compound.

23. The composition of claim 22 wherein the zinc compound is selected from the group consisting of Zn(OH)₂, ZnSO₄, Zn(ClO₄)₂, Zn₂O, Zn(NO₃)₂, ZnCl₂, 3Zn(OH)₂.ZnCl₂, Zn(OH)₂.ZnCO₃, and 3Zn(OH)₂.ZnSO₄.

24. The compound of claim 14 wherein the boron compound is selected from the group consisting of alkali metal borate, amine borate, boric acid, salts of boric acid, boric ester, fluoroboric acid, and salts of fluoroboric acid.

25. The composition of claim 14 wherein
the fungicidal and bactericidal metal compound is at least 8 percent by weight of the composition,
the triazole compound is at least 0.10 percent by weight of the composition,
the combination of the first and second quaternary ammonium compounds is at least 2 percent by weight of the composition, and
the boric compound is at least 5 percent by weight of the composition.

26. The composition of claim 25 wherein
the fungicidal and bactericidal metal compound ranges from 8 to 22 percent by weight of the composition,
the triazole compound ranges from 0.10 to 3 percent by weight of the composition,
the combination of the first and second quaternary ammonium compounds ranges from 2 to 15 percent by weight of the composition, and
the boric compound ranges from 5 to 15 percent by weight of the composition.

27. The composition of claim 25 further comprising at least one alkylamine and water.

28. The composition of claim 27 wherein the at least one alkylamine is monoethanolamine.

29. The composition of claim 27 wherein the at least one alkylamine is monoethanolamine and triethanolamine.

30. The composition of claim 27 wherein the alkylamines are at least 30 percent by weight of the composition, and the water is at least 13 percent by weight of the composition.

31. The composition of claim 26 wherein the combination of the first and second quaternary ammonium compounds has a ratio of weight percent in the composition between the first quaternary ammonium compound and the second quaternary ammonium compound ranging from 3:1 to 12:1.

32. The composition of claim 31 wherein the ratio between the first quaternary ammonium compound and the second quaternary ammonium compound is 4:1.

33. The composition of claim 31 wherein the ratio between the first quaternary ammonium compound and the second quaternary ammonium compound is 10:1.

34. A wood preservative composition comprising
at least 2 percent by weight of the composition is a combination of at least a first and a second quaternary ammonium compound, wherein the first quaternary ammonium compound has the structure: 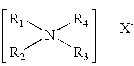
and the second quaternary ammonium compound has the structure: 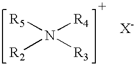
and
R₁ is selected from the from the group consisting of a C₂₋₃₀ alkyl group, a C₂₋₃₀ alkenyl group, a C₂₋₃₀ alkynyl group, a C₂₋₃₀ aryl group, a C₂₋₃₀ aralkyl group, a C₂₋₃₀ aroyl group, a C₂₋₃₀ acyl group, a C₂₋₃₀ cycloalkyl group, C₂₋₃₀ cycloalkenyl group, or a C₂₋₃₀ cycloalkynyl group;
R₂ and R₃ can be the same or different and are independently selected from the group consisting of a C₁₋₄ hydroxyalkyl group, a C₁₋₄ alkyl group, a C₂₋₅ hydroxyalkenyl group, a C₂₋₅ hydroxyalkynyl group, a C₃₋₅ hydroxyaryl group;
R₄ is selected from the group consisting of a C₁₋₄ alkyl group, a C₂₋₅ alkenyl group, a C₂₋₅ alkynyl group, a C₃₋₅ aryl group;
R₅ is selected from the group consisting of a C₁₂₋₂₀ alkyl group, a C₁₂₋₂₀ alkenyl group, a C₁₂₋₂₀ alkynyl group, a C₁₂₋₂₀ aryl group, a C₁₂₋₂₀ aralkyl group, a C₁₂₋₂₀ aroyl group, a C₁₂₋₂₀ acyl group, a C₁₂₋₂₀ cycloalkyl group, C₁₂₋₂₀ cycloalkenyl group, or a C₁₂₋₂₀ cycloalkynyl group; and
X is selected from the group consisting of a chloride, bromide, carbonate, sulfate, acetate or phosphate ion;
at least 8 percent by weight of the composition is a fungicidal and bactericidal metal compound;
at least 0.10 percent by weight of the composition is a triazole compound;
at least 30 percent by weight of the composition is at least one amine compound; and
at least 5 percent by weight of the composition is a boron compound.

35. The composition of claim 34 wherein the triazole compound is a cyproconazole.

36. The composition of claim 35 wherein the cyproconazole is α-(4-chlorophenyl)-α-(1-cyclopropylethyl)-1H-1,2,4-triazole-1-ethanol.

37. The composition of claim 34 wherein the triazole compound is selected from the group consisting of hexaconazole, difenoconazole, tebuconazole, propiconazole, azaconazole, and cyproconazole.

38. The composition of claim 34 wherein the fungicidal and bactericidal metal compound is a copper compound.

39. The composition of claim 38 wherein copper compound is selected from the group consisting of Cu(OH)₂, CuSO₄, Cu(ClO₄)₂, Cu₂O, Cu(NO₃)₂, CuCl₂, 3Cu(OH)₂.CuCl₂, Cu(OH)₂.CuCO₃, and 3Cu(OH)₂.CuSO₄.

40. The composition of claim 38 wherein the copper compound is copper carbonate.

41. The composition of claim 34 wherein the fungicidal and bactericidal metal compound is a zinc compound.

42. The composition of claim 41 wherein the zinc compound is selected from the group consisting of Zn(OH)₂, ZnSO₄, Zn(ClO₄)₂, Zn₂O, Zn(NO₃)₂, ZnCl₂, 3Zn(OH)₂.ZnCl₂, Zn(OH)₂.ZnCO₃, and 3Zn(OH)₂.ZnSO₄.

43. The compound of claim 34 wherein the boron compound is selected from the group consisting of alkali metal borate, amine borate, boric acid, salts of boric acid, boric ester, fluoroboric acid, and salts of fluoroboric acid.

44. The composition of claim 34 wherein
the fungicidal and bactericidal metal compound ranges from 8 to 22 percent by weight of the composition,
the triazole compound ranges from 0.10 to 3 percent by weight of the composition,
the combination of the first and second quaternary ammonium compounds ranges from 2 to 15 percent by weight of the composition,
the at least one amine compound ranges between 35 to 50 percent by weight of the composition, and
the boric compound ranges from 5 to 15 percent by weight of the composition.

45. The composition of claim 34 further comprising water.

46. The composition of claim 34 wherein the at least one amine compound is monoethanolamine.

47. The composition of claim 34 wherein the at least one amine compound is monoethanolamine and triethanolamine.

48. The composition of claim 34 wherein the combination of the first and second quaternary ammonium compounds has a ratio of weight percent in the composition between the first quaternary ammonium compound and the second quaternary ammonium compound ranging from 3:1 to 12:1.

49. The composition of claim 34 wherein the ratio between the first quaternary ammonium compound and the second quaternary ammonium compound is 4:1.

50. The composition of claim 34 wherein the ratio between the first quaternary ammonium compound and the second quaternary ammonium compound is 10:1.

51. A process for treating wood or wood-containing products comprising the steps of:
applying to wood or wood-containing products a composition comprising
an effective amount of a combination of at least a first and a second quaternary ammonium compound, wherein the first quaternary ammonium compound has the structure: 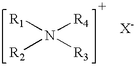
and the second quaternary ammonium compound has the structure: 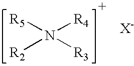
and
R₁ is selected from the from the group consisting of a C₂₋₃₀ alkyl group, a C₂₅₋₃₀ alkenyl group, a C₂₅₋₃₀ alkynyl group, a C₂₋₃₀ aryl group, a C₂₋₃₀ aralkyl group, a C₂₋₃₀ aroyl group, a C₂₋₃₀ acyl group, a C₂₋₃₀ cycloalkyl group, C₂₋₃₀ cycloalkenyl group, or a C₂₋₃₀ cycloalkynyl group;
R₂ and R₃ can be the same or different and are independently selected from the group consisting of a C₁₋₄ hydroxyalkyl group, a C₁₋₄ alkyl group, a C₂₋₅ hydroxyalkenyl group, a C₂₋₅ hydroxyalkynyl group, a C₃₋₅ hydroxyaryl group;
R₄ is selected from the group consisting of a C₁₋₄ alkyl group, a C₂₋₅ alkenyl group, a C₂₋₅ alkynyl group, a C₃₋₅ aryl group;
R₅ is selected from the group consisting of a C₁₂₋₂₀ alkyl group, a C₁₂₋₂₀ alkenyl group, a C₁₂₋₂₀ alkynyl group, a C₁₂₋₂₀ aryl group, a C₁₂₋₂₀ aralkyl group, a C₁₂₋₂₀ aroyl group, a C₁₂₋₂₀ acyl group, a C₁₂₋₂₀ cycloalkyl group, C₁₂₋₂₀ cycloalkenyl group, or a C₁₂₋₂₀ cycloalkynyl group; and
X is selected from the group consisting of a chloride, bromide, carbonate, sulfate, acetate or phosphate ion;
an effective amount of a fungicidal and bactericidal metal compound selected from the group consisting of Cu(OH)₂, CuSO₄, Cu(ClO₄)₂, Cu₂O, Cu(NO₃)₂, CuCl₂, 3Cu(OH)₂.CuCl₂, Cu(OH)₂.CuCO₃, 3Cu(OH)₂.CuSO₄, Zn(OH)₂, ZnSO₄, Zn(ClO₄)₂, Zn₂O, Zn(NO₃)₂, ZnCl₂, 3Zn(OH)₂.ZnCl₂, Zn(OH)₂.ZnCO₃, and 3Zn(OH)₂.ZnSO₄;
an effective amount of a triazole compound selected from the group consisting of hexaconazole, difenoconazole, tebuconazole, propiconazole, azaconazole, and cyproconazole; and
an effective amount of a boron compound selected from the group consisting of alkali metal borate, amine borate, boric acid, salts of boric acid, boric ester, fluoroboric acid, and salts of fluoroboric acid.

52. The process of claim 51 wherein the composition further contains an amine compound, and after the application of the composition to the wood or wood-containing product the ratio between the amine compound to the metal of the fungicidal and bactericidal metal compound within the wood or wood-containing product between 3.5 to 5.0 parts per cubic feet, and the metal of the fungicidal and bactericidal metal compound to the triazole compound has a ratio within the wood or wood-containing product between 6.0 to 70.0 parts per cubic feet.

53. The process of claim 51 wherein the fungicidal and bactericidal metal compound is at least 8 percent by weight of the composition,
the triazole compound is at least 0.10 percent by weight of the composition,
the combination of the first and second quaternary ammonium compounds is at least 2 percent by weight of the composition, and
the boric compound is at least 5 percent by weight of the composition.

54. The process of claim 51 wherein the triazole compound is a cyproconazole.

55. The process of claim 51 wherein the cyproconazole is α-(4-chlorophenyl)-α-(1-cyclopropylethyl)-1H-1,2,4-triazole-1-ethanol.

56. The process of claim 51 wherein the fungicidal and bactericidal metal compound is copper carbonate.

57. The process of claim 51 wherein
the fungicidal and bactericidal metal compound ranges from 8 to 22 percent by weight of the composition,
the triazole compound ranges from 0.10 to 3 percent by weight of the composition,
the combination of the first and second quaternary ammonium compounds ranges from 2 to 15 percent by weight of the composition,
the at least one amine compound ranges between 35 to 50 percent by weight of the composition, and
the boric compound ranges from 5 to 15 percent by weight of the composition.

58. The process of claim 57 wherein the ratio between the first quaternary ammonium compound and the second quaternary ammonium compound in the composition is about 4:1, and
retained in the wood or wood containing product are the metal from the fungicidal and bactericidal metal compound at about 0.200 parts per cubic foot, and the boric compound at about 0.16 parts per cubic foot.

59. The process of claim 57 wherein the ratio between the first quaternary ammonium compound and the second quaternary ammonium compound in the composition is about 10:1, and
retained in the wood or wood containing product are the metal from the fungicidal and bactericidal metal compound at about 0.04 parts per cubic foot, and the boric compound at about 0.032 parts per cubic foot.

60. A wood preservative composition comprising
an effective amount of a combination of at least a first quaternary ammonium compound, wherein the first quaternary ammonium compound has the structure: 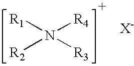
R₁ is selected from the from the group consisting of a C₁₂₋₁₅ alkyl group, a C₁₂₋₁₅ alkenyl group, a C₁₂.₅ alkynyl group, a C₁₂₋₁₅ aryl group, a C₁₂₋₁₅ aralkyl group, a C₁₂₋₁₅ aroyl group, a C₁₂₋₁₅ acyl group, a C₁₂₋₁₅ cycloalkyl group, C₁₂₋₁₅ cycloalkenyl group, or a C₁₂₋₁₅ cycloalkynyl group;
R₂ and R₃ can be the same or different and are independently selected from the group consisting of a C₁₋₄ hydroxyalkyl group, a C₁₋₄ alkyl group, a C₂₋₅ hydroxyalkenyl group, a C₂, hydroxyalkynyl group, a C₃₋₅ hydroxyaryl group;
R₄ is selected from the group consisting of a C₁₋₄ alkyl group, a C₂₋₅ alkenyl group, a C₂₋₅ alkynyl group, a C₃₋₅ aryl group; and
X is selected from the group consisting of a chloride, bromide, carbonate, sulfate, acetate or phosphate ion; an effective amount of a fungicidal and bactericidal metal compound;
an effective amount of a triazole compound; and
a mold inhibitor that is emulsified with the metal from the fungicidal and bactericidal metal compound in solution.

61. The wood preservative composition of claim 61 further comprising a second quaternary ammonium compound having the structure: 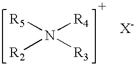
R₅ is selected from the group consisting of a C₁₆₋₂₀ alkyl group, a C₁₆₋₂₀ alkenyl group, a C₁₆₋₂₀ alkynyl group, a C₁₆₋₂₀ aryl group, a C₁₆₋₂₀ aralkyl group, a C₁₆₋₂₀ aroyl group, a C₁₆₋₂₀ acyl group, a C₁₆₋₂₀ cycloalkyl group, C₁₆₋₂₀ cycloalkenyl group, or a C₁₆₋₂₀ cycloalkynyl group.

62. The composition of claim 60 wherein the triazole compound is a cyproconazole.

63. The composition of claim 62 wherein the cyproconazole is α-(4-chlorophenyl)-α-(1-cyclopropylethyl)-1H-1,2,4-triazole-1-ethanol in its racemic form.

64. The composition of claim 60 wherein the triazole compound is selected from the group consisting of hexaconazole, difenoconazole, tebuconazole, propiconazole, azaconazole, and cyproconazole.

65. The composition of claim 60 wherein the mold inhibitor is a tribromophenyl.

66. The composition of claim 60 wherein the fungicidal and bactericidal metal compound is a copper compound.

67. The composition of claim 66 wherein copper compound is selected from the group consisting of Cu(OH)₂, CuSO₄, Cu(ClO₄)₂, Cu₂O, Cu(NO₃)₂, CuCl₂, 3Cu(OH)₂.CuCl₂, Cu(OH)₂.CuCO₃, and 3Cu(OH)₂.CuSO₄.

68. The composition of claim 66 wherein the copper compound is copper carbonate.

69. The composition of claim 60 wherein the fungicidal and bactericidal metal compound is a zinc compound.

70. The composition of claim 69 wherein the zinc compound is selected from the group consisting of Zn(OH)₂, ZnSO₄, Zn(ClO₄)₂, Zn₂O, Zn(NO₃)₂, ZnCl₂, 3Zn(OH)₂.ZnCl₂, Zn(OH)₂.ZnCO₃, and 3Zn(OH)₂.ZnSO₄.

71. The composition of claim 61 wherein the fungicidal and bactericidal metal compound is at least 8 percent by weight of the composition, the triazole compound is at least 0.10 percent by weight of the composition, and the combination of the first and second quaternary ammonium compounds is at least 2 percent by weight of the composition.

72. The composition of claim 60 further comprising a boron compound.

73. The composition of claim 72 wherein the boron compound is selected from the group consisting of alkali metal borate, amine borate, boric acid, salts of boric acid, boric ester, fluoroboric acid, and salts of fluoroboric acid.

74. A process for treating wood or wood-containing products comprising the steps of:
applying to wood or wood-containing products a composition comprising
an effective amount of a combination of at least a first and a second quaternary ammonium compound, wherein the first quaternary ammonium compound has the structure: 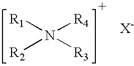
R₁ is selected from the from the group consisting of a C₂₋₃₀ alkyl group, a C₂₋₃₀ alkenyl group, a C₂₋₃₀ alkynyl group, a C₂₋₃₀ aryl group, a C₂₋₃₀ aralkyl group, a C₂₋₃₀ aroyl group, a C₂₋₃₀ acyl group, a C₂₋₃₀ cycloalkyl group, C₂₋₃₀ cycloalkenyl group, or a C₂₋₃₀ cycloalkynyl group;
R₂ and R₃ can be the same or different and are independently selected from the group consisting of a C₁₋₄ hydroxyalkyl group, a C₁₋₄ alkyl group, a C₂₋₅ hydroxyalkenyl group, a C₂₋₅ hydroxyalkynyl group, a C₃₋₅ hydroxyaryl group;
R₄ is selected from the group consisting of a C₁₋₄ alkyl group, a C₂₋₅ alkenyl group, a C₂₋₅ alkynyl group, a C₃₋₅ aryl group; and
X is selected from the group consisting of a chloride, bromide, carbonate, sulfate, acetate or phosphate ion;
an effective amount of a fungicidal and bactericidal metal compound selected from the group consisting of Cu(OH)₂, CuSO₄, Cu(ClO₄)₂, Cu₂O, Cu(NO₃)₂, CuCl₂, 3Cu(OH)₂.CuCl₂, Cu(OH)₂.CuCO₃, 3Cu(OH)₂.CuSO₄, Zn(OH)₂, ZnSO₄, Zn(ClO₄)₂, Zn₂O, Zn(NO₃)₂, ZnCl₂, 3Zn(OH)₂.ZnCl₂, Zn(OH)₂.ZnCO₃, and 3Zn(OH)₂.ZnSO₄;
an effective amount of a triazole compound selected from the group consisting of hexaconazole, difenoconazole, tebuconazole, propiconazole, azaconazole, and cyproconazole; and
an effective amount of a boron compound selected from the group consisting of alkali metal borate, amine borate, boric acid, salts of boric acid, boric ester, fluoroboric acid, and salts of fluoroboric acid.

75. The process of claim 74 further comprising a second quaternary ammonium compound having the structure: 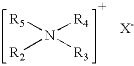
R₅ is selected from the group consisting of a C₁₆₋₂₀ alkyl group, a C₁₆₋₂₀ alkenyl group, a C₁₆₋₂₀ alkynyl group, a C₁₆₋₂₀ aryl group, a C₁₆₋₂₀ aralkyl group, a C₁₆₋₂₀ aroyl group, a C₁₆₋₂₀ acyl group, a C₁₆₋₂₀ cycloalkyl group, C₁₆₋₂₀ cycloalkenyl group, or a C₁₆₋₂₀ cycloalkynyl group.

76. The process of claim 74 wherein the composition further contains an amine compound, and after the application of the composition to the wood or wood-containing product the ratio between the amine compound to the metal of the fungicidal and bactericidal metal compound within the wood or wood-containing product between 3.5 to 5.0 parts per cubic feet, and the metal of the fungicidal and bactericidal metal compound to the triazole compound has a ratio within the wood or wood-containing product between 6.0 to 70.0 parts per cubic feet.

77. The process of claim 75 wherein the fungicidal and bactericidal metal compound is at least 8 percent by weight of the composition,
the triazole compound is at least 0.10 percent by weight of the composition,
the combination of the first and second quaternary ammonium compounds is at least 2 percent by weight of the composition, and
the boric compound is at least 5 percent by weight of the composition.

78. The process of claim 74 wherein the triazole compound is a cyproconazole.

79. The process of claim 74 wherein the cyproconazole is α-(4-chlorophenyl)-α-(1-cyclopropylethyl)-1H-1,2,4-triazole-1-ethanol.

80. The process of claim 74 wherein the fungicidal and bactericidal metal compound is copper carbonate.

81. The process of claim 75 wherein
the fungicidal and bactericidal metal compound ranges from 8 to 22 percent by weight of the composition,
the triazole compound ranges from 0.10 to 3 percent by weight of the composition,
the combination of the first and second quaternary ammonium compounds ranges from 2 to 15 percent by weight of the composition,
the at least one amine compound ranges between 35 to 50 percent by weight of the composition, and
the boric compound ranges from 5 to 15 percent by weight of the composition.

82. The process of claim 75 wherein the ratio between the first quaternary ammonium compound and the second quaternary ammonium compound in the composition is about 4:1, and
retained in the wood or wood containing product are the metal from the fungicidal and bactericidal metal compound at about 0.200 parts per cubic foot, and the boric compound at about 0.16 parts per cubic foot.

83. The process of claim 75 wherein the ratio between the first quaternary ammonium compound and the second quaternary ammonium compound in the composition is about 10:1, and
retained in the wood or wood containing product are the metal from the fungicidal and bactericidal metal compound at about 0.04 parts per cubic foot, and the boric compound at about 0.032 parts per cubic foot.
